(19) United States
(12) Patent Application Publication
(10) Pub. No.: US 2008/0303321 A1
(43) Pub. Date: Dec. 11, 2008

(54) Base for a Child Safety Support

(75) Inventor: Iain Powell, Hampshire (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: BRITAX EXCELSIOR LIMITED, Hampshire (GB)

(21) Appl. No.: 11/568,849

(22) PCT Filed: May 6, 2003
(86) PCT No.: PCT/GB05/01732

§ 371 Date: Jul. 31, 2008

(30) Foreign Application Priority Data
May 8, 2004 (GB) 0410303.2

(51) Int. Cl. B60N 2/28

(52) U.S. Cl. 297/216.11

(57) ABSTRACT

A base (1) for a child safety seat to be used with an adult seat in a vehicle equipped with ISOFIX loops comprises an upper moulding (2) and a lower moulding (3) screwed and clipped together. The upper moulding comprises a pair of front humps (8) and a pair of rear humps (9) with a flat portion (10) between the pairs. The humps have moulded recesses (11) for the front and rear anchor bars (51, 52) of a conventional infant carrier (53). Below release button (61) the base has formation (71) for pivotal connection of foot prop (72) is clipped up under the base, anti-rebound flap (38) is folded against the prop and ISOFIX latches (34) are pivoted in towards the front of the base. For use, ISOFIX latches (34) are turned backwards, anti-rebound member (38) is swung around from below to above the base and foot prop (72) is extended down to abut the floor. To fit infant carrier (53), its anchor bars (51, 52) are engaged in recesses (11) and the infant carrier is pushed down to push hooks (45) away.

The present invention relates to a base for a child safety support and in particular to a base for a child safety support to be used in a vehicle with an adult seat equipped with ISOFIX loops.

In this specification, the term “child safety support” is used to encompass both child safety seats and infant carriers, which are provided with a harness for securing the child in the support in case of an accident. The term child safety support is used because in a seat a child is more upright than lying and in an infant carrier the child can be more lying than sitting, and thus the term child safety support encompasses the fall range of child posture from the most upright seat to the most recumbent infant carrier.

In this specification, the term “child safety support” includes both rearwards facing infant carriers, rearwards facing Group 1 children's seats and forwards facing Group 1 childrens' seats at least, all being adapted for accident-secure attachment to a base to be secured in a vehicle. The child safety seats can in addition be adapted to be secured in a vehicle via an adult safety belt.

A base for a seat is convenient in allowing a single fitting to the car to be used for at least two sizes of child safety support, namely a Group 0+ infant carrier and a Group 1 rear facing seat such as are necessary as children grow.

For youngest children, i.e. infants, a forwards facing seat is not acceptable. An infant carrier is fitted in the car facing backwards. In some countries, this practice is continued for pre-school age children. In terms of groupings used in the industry, the former are Group 0+ children and the latter are Group 1 children.

ISOFIX is a system for fixing child safety seats in vehicles. It is established under UNECE Regulation 44.03. Essentially it provides for a pair of steel loops in an adult seat at the junction between the back and the cushion of the seat, the child safety seat being able to be latched onto the loops.

ISOFIX seats can suffer from excessive forwards movement in pivoting about the latch loops, if not provided with a top tether, i.e. a tether for the back of the seat acting at its top.

It is known from European Patent Application No. 1,279,554 to provide a seat base to be secured in the adult seat by means of its adult seat belt with a foot prop for supporting the front of the seat base.

The object of the present invention is to provide an improved base for a child safety support.

As claimed in the invention there is provided a base for a child safety support to be used with an adult seat in a vehicle equipped with ISOFIX loops, the base comprising:
a body configured for positioning on a cushion of an adult seat;
a pair of ISOFIX latches attached to the rear of the body;
a foot prop attached at or near the front of the body for extending past the front edge of the cushion of the adult seat and abutting the floor of the vehicle; and
a safety support engagement mechanism for engaging a safety seat to the body.

Whilst it is envisaged that the body may be of unitary and/or moulded construction with sufficient inherent strength to resist accident loads, preferably it includes a reinforcement, connecting the ISOFIX latches to the safety support engagement mechanism. Conveniently this is in the form of a U-shaped metal frame having the latches at the distal ends of its limbs. The latches and the limbs again can be connected directly. However, in the preferred embodiment, they are connected via a cross-member interconnecting the distal ends, and having the latches at the terminal ends of the cross-member.

The ISOFIX latches can be irrotationally attached to the reinforcement. However, again preferably, they are pivotally attached, for ease of connection and ease of stowage when not in use. Conveniently they are pivoted via the cross-member.

The foot prop is preferably attached at the front of the body. It provides resistance to rotation of the base during initial stages of an accident, i.e. about the ISOFIX loops towards the seat cushion. To provide resistance to rebound rotation, an anti-rebound member is preferably provided at the latch end of the body to abut the back of the adult seat. The cross-member provides a convenient attachment for the member. The latter is preferably pivotal about the cross-member for stowage and provided with abutments with the top surface of the base for limiting movement of the base and the member towards each other in a rebound.

The safety support engagement mechanism conveniently is configured as two pairs of hooks pivoted to the U-frame—two at each long limb—and ganged together for resilient urging to their engaged position. A central longitudinal member, conveniently of moulded plastics material for reduced mass, is provided for the ganged connection. Preferably it is provided with an inertia interlock, released on application of manual force to release the engagement means.

To help understanding of the invention, a specific embodiment thereof will now be described by way of example and with reference to the accompanying drawings, in which:

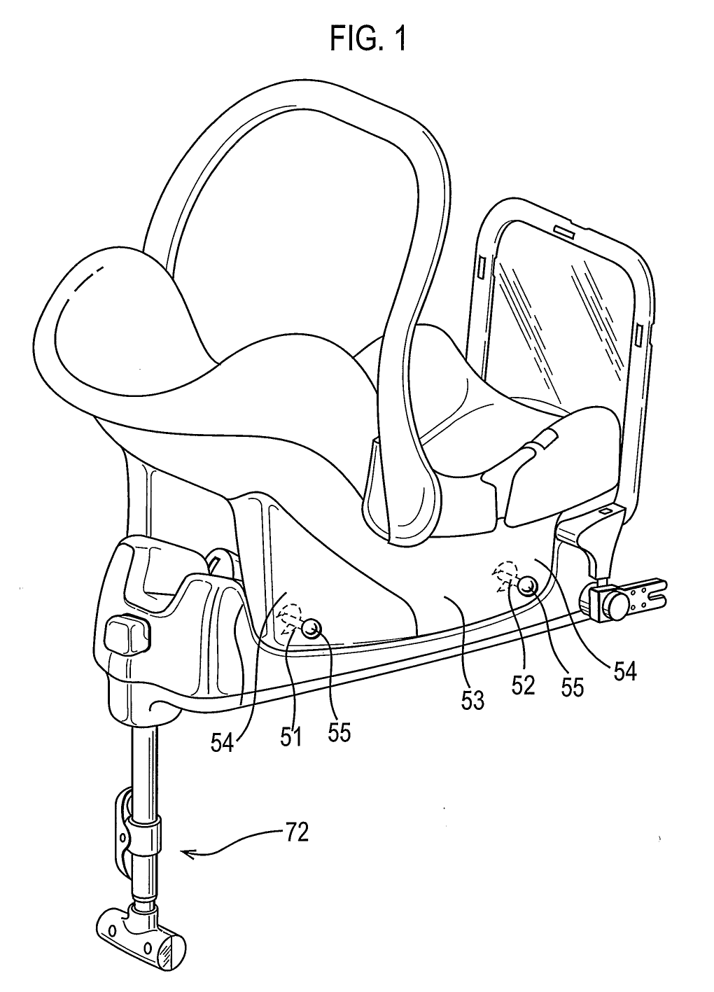

FIG. 1 is a perspective view of a base for a child safety support in use with an infant carrier;

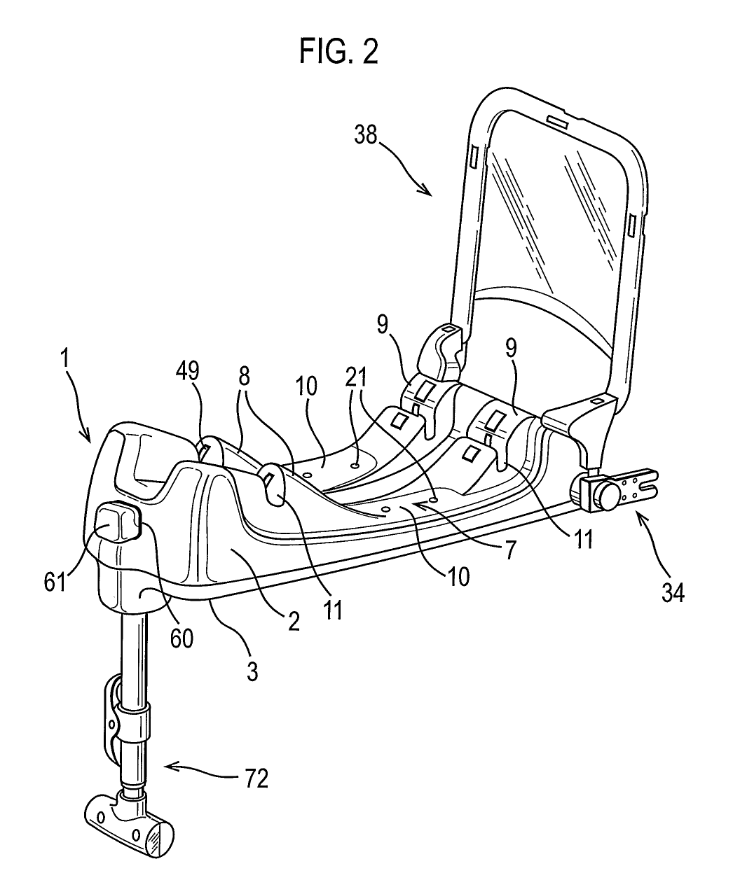

FIG. 2 is a similar view with the carry cot removed;

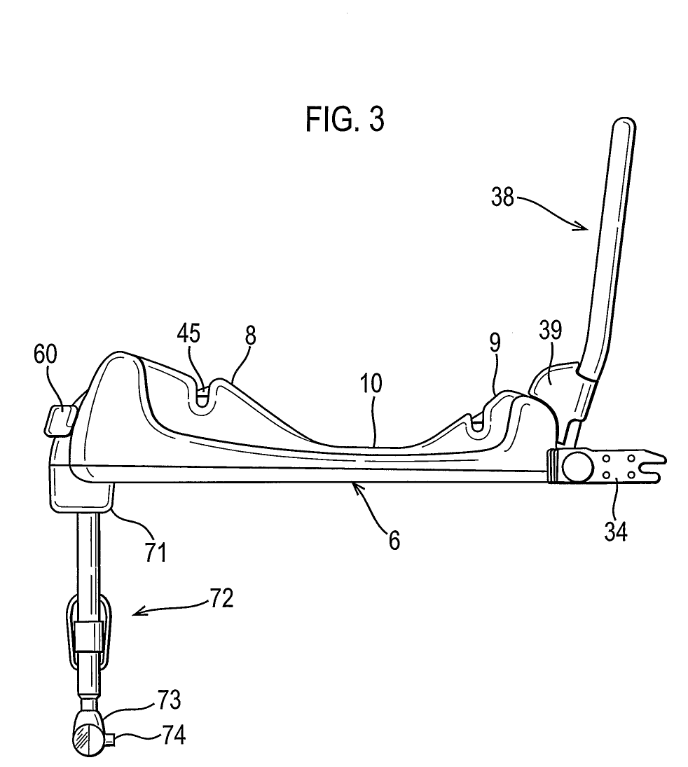

FIG. 3 is a side view of the base in its use configuration;

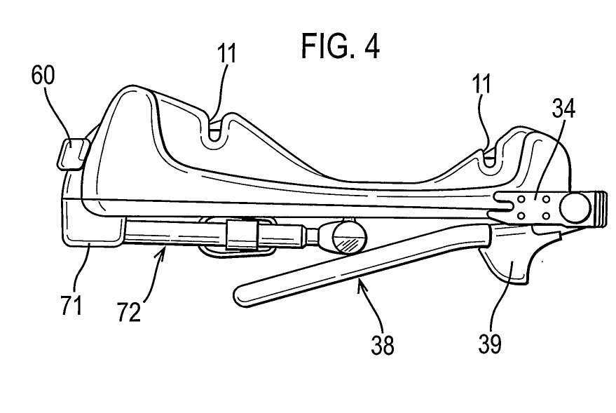

FIG. 4 is a side view of the base in its stowed configuration;

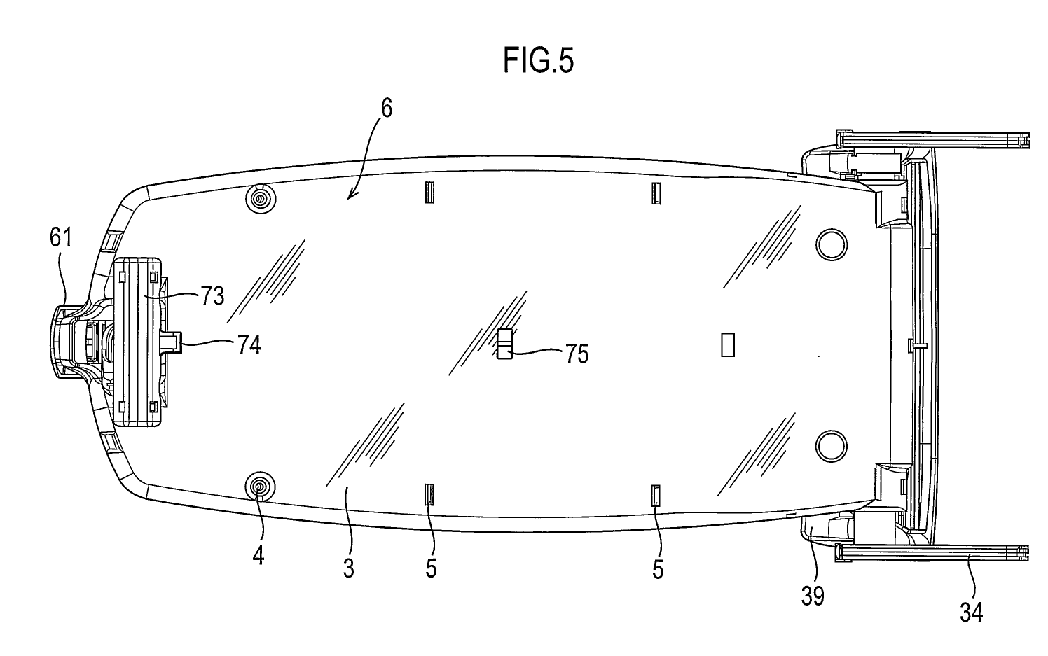

FIG. 5 is an underneath view of the base;

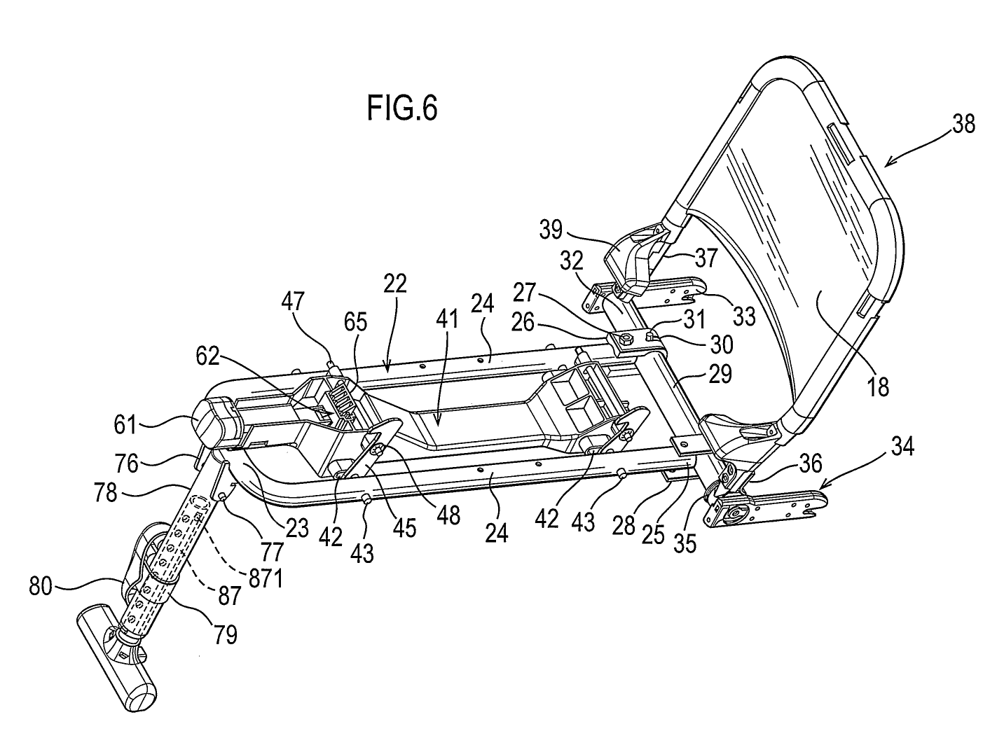

FIG. 6 is an isometric view of the base with its outer mouldings removed;

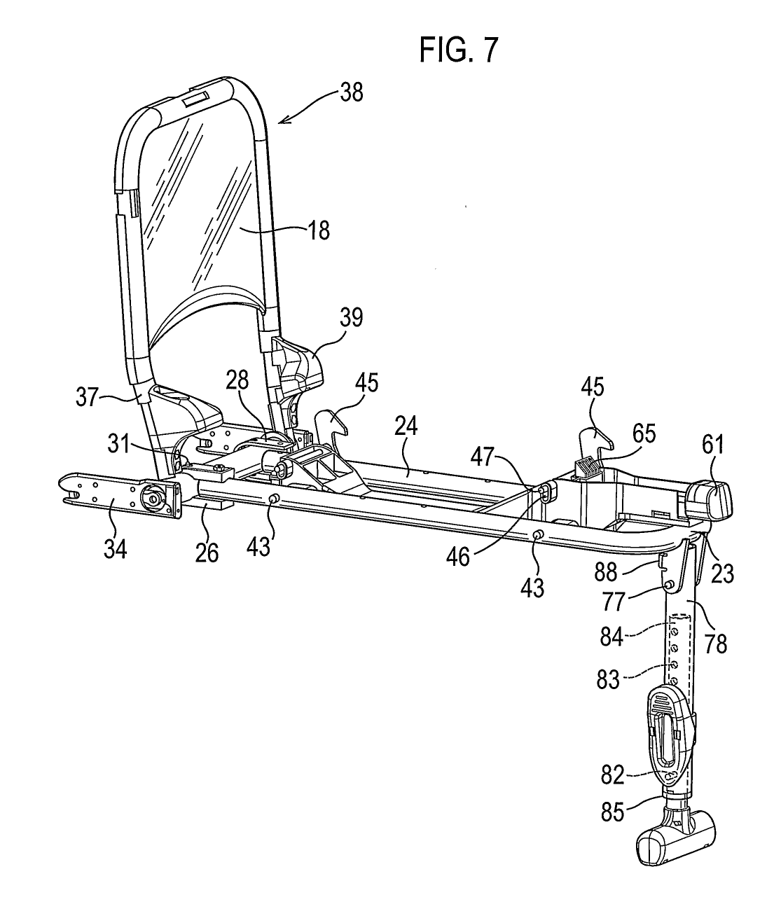

FIG. 7 is a similar view from the other side (NB. two hooks for securing the carry cot are omitted for clarity);

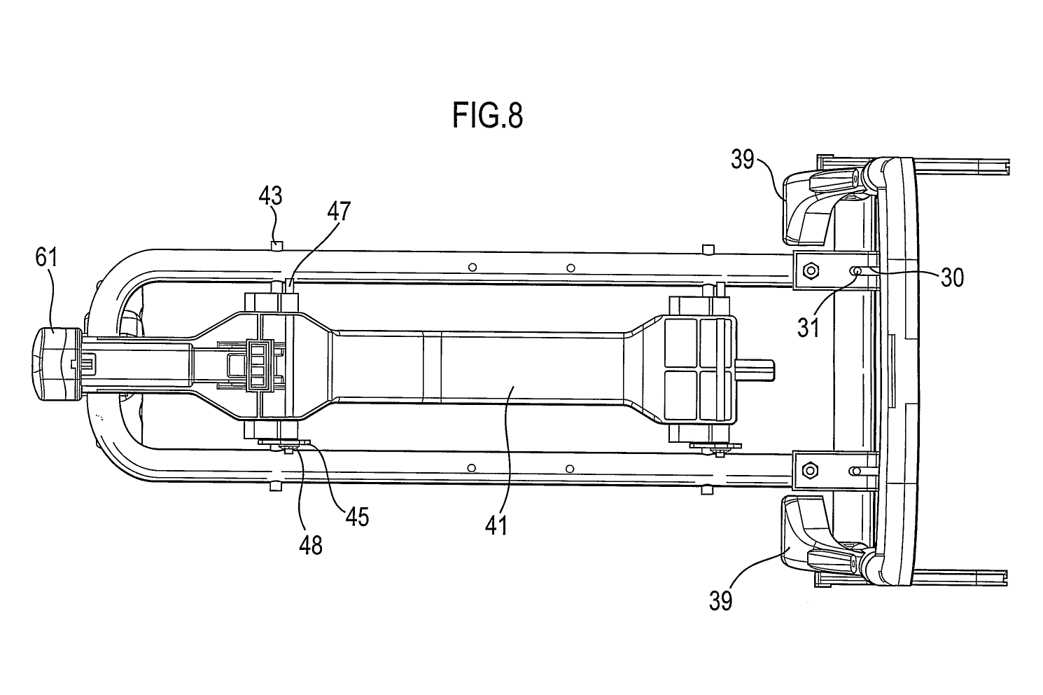

FIG. 8 is a similar plan view;

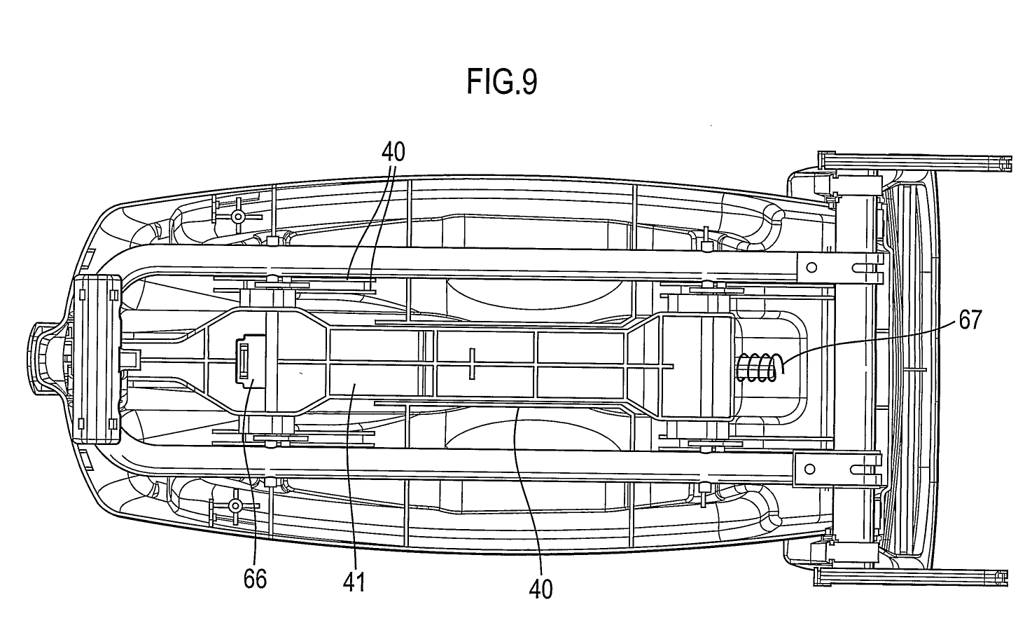

FIG. 9 is an underneath view similar to FIG. 5, but with the bottom moulding removed;

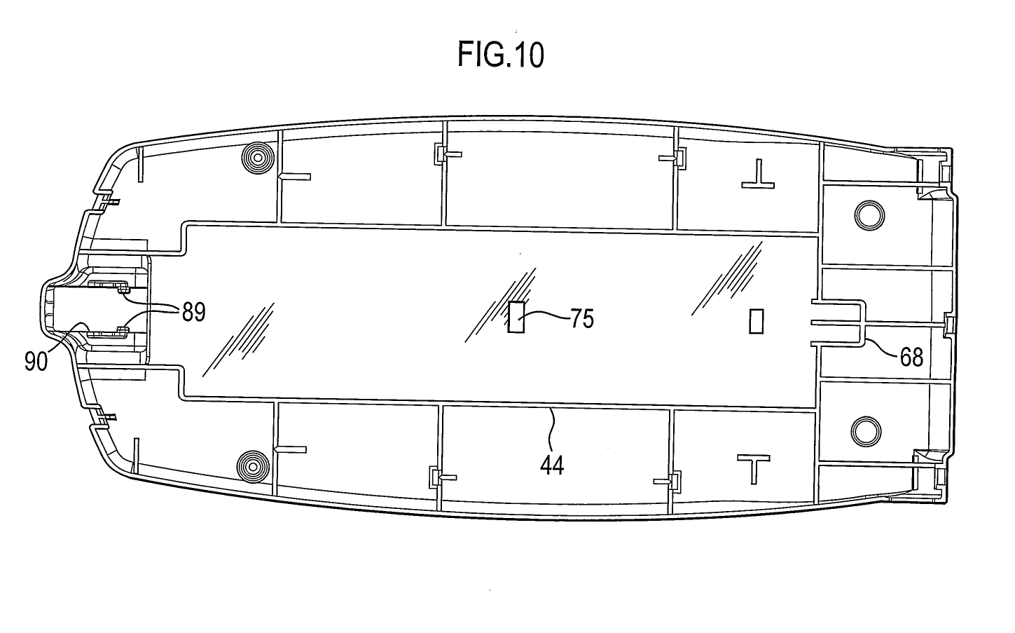

FIG. 10 is a plan view of the bottom moulding; and

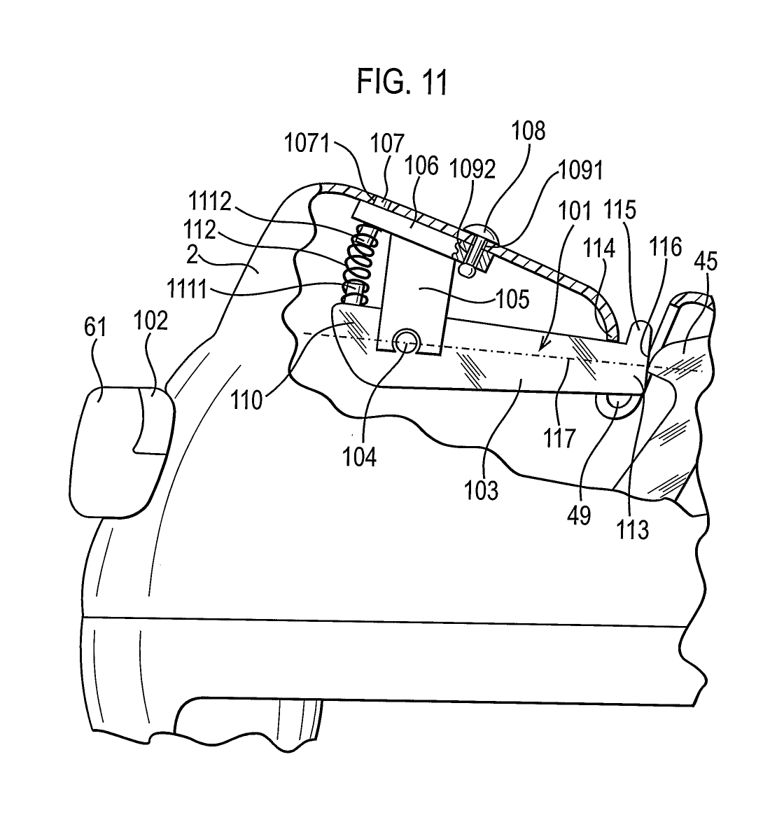

FIG. 11 is a partially sectioned side view of the front end of the base, showing a hook retainer in a variant.

Referring to the drawings, the child safety support base 1 thereshown comprises an upper moulding 2 and a lower moulding 3 screwed 4 and clipped 5 together. Except for a formation at the front, the under-surface 6 of the lower moulding is flat. The top surface 7 of the upper moulding has a pair of front humps 8 and a pair of rear humps 9, with a lower flat 10 therebetween.

The humps have moulded recesses 11 for front and rear anchor bars 51,52 of an otherwise conventional infant carrier 53, the anchor bars extending between front and rear side flanges 54 and being retained by end fittings 55. The base humps are contoured to be received between the side flanges.

Internally and riveted 21 at the flat 10, the base includes a reinforcing frame 22 of steel tube, bent to U-shape, the junction 23 of its long limbs 24 being at the front of the base. Connected to the rear, distal ends 25 of the long limbs, via bearing mouldings 26 and bolted on 27 encircling steel straps 28 is a steel cross tube 29. The straps have slots 30 in which engage roll pins 31 pressed into the cross tube. The latter is thus located longitudinally whilst free to rotate by a half turn.

Welded to the terminal ends 32 of the cross tube are inner casings 33 of ISOFIX latches 34. In so far as these are conventional in themselves, they will not be described in further detail.

At the emergence of the cross tube from the base mouldings 2,3 the cross tube carries bearings 35 for steel straps 36 riveted to a steel tube hoop 37 forming an anti-rebound member 38. This has moulded, anti-rotation stops 39 riveted to it, the stops being shaped complementarily to the rear humps 9. The hoop 37 is partially filled in with a clipped-on thermo-forming 18.

The upper moulding has internal ribs 40, which define a central slot for a release member 41 formed as a injection moulding. This has two cross slots 42 for pivot pins 43 extending through the limbs 24 of the U-frame 22. The pins are located longitudinally by internal ribs 44 on the lower moulding and provide pivot points for hooks 45 at the recesses 11 for the anchor bars 51,52 of the infant carrier 53. The release member 41 carries at cross-bores 46 for upper pins 47, passing through the hooks 45 and held on by spring clips 48, whereby longitudinal movement of the release member is translated into rotation of the hooks through openings 49 in the upper moulding at the recesses 11. The hooks are guided laterally by further internal ribs 401.

At the front of the upper moulding in another opening 60, a release button 61 is provided. It is slidably carried on the release member 41 and co-operates with an inter-lock 62 via a pivot and a spring, neither of these being shown. The interlock has an ear 65 extending through an opening 66 in the upper moulding between the front humps and in line with recesses 11 in the front humps. The arrangement is such that the ear rises in front of the anchor bar 51 and it and the release member 41 are prevented from moving back under inertia in an accident. Normally the release member is biased forwards by a spring 67 carried at its rear end and reacting on a rib 68 on the lower moulding.

Below the release button, the front of the lower moulding has a formation 71 for a pivotal connection of a foot prop 72. In order to allow the prop to stow with it foot 73 per se clipped to the lower moulding by a clip 74 at an aperture 75, the pivotal connection is below the flat under-surface 6 of the lower moulding. The connection is comprised of a pair of depending tabs 76 welded to the U frame and carrying a pivot pin 77. The pin passes through an outer telescopic metal tube 78 of the prop. This carries a welded on U 79 to which is clipped a rocker 80. This is biased by a spring (not shown) to cause a peg 82 carried on its lower leg to engage through a hole in the outer tube in a selected one of a series of holes 83 in an inner tube 84. To keep the tubes from raffling and to keep the holes 83 at the correct rotary position, a moulded liner 85 extends between the tubes. It is located by the pin 77 passing through it. It has a longitudinal slot 87, in which a roll pin 871 pressed into the inner tube engages. The foot prop is stopped from pivoting forwards beyond a right angle to the underside of the base by abutment of the top end of the outer tube, above the pivot, with a web 88 between the tabs 76. It is loosely held in this position by resilient detents 89 in the lower moulding at the edge of the an aperture 90 in the formation 71.

For stowage, the foot prop 72 is clipped up under the base, the anti-rebound member 38 is folded against the prop and the ISOFIX latches 34 are pivoted in towards the front of the base.

For use, the ISOFIX latches are turned backwards, the anti-rebound member is swung around from beneath to above the base and the foot prop is swung forwards. The ISOFIX latches are engaged on loops at an adult seat and the foot prop is extended down to abut the floor. It is adjusted in length so that it rather than the front of the adult seat cushion supports the front of the base. To fit the infant carrier, its anchor bars 51,52 are engaged in the recesses 11 and the infant carrier is pushed down to push the hooks 45 away. Once the bars have passed them, they hook over the top of the bars. For removal of the infant carrier alone again, the release button is pressed in withdrawing the hooks, which allow the infant carrier to be lifted out.

In the event of a frontal accident, the centre of gravity of the child, infant carrier and base is appreciably above the ISOFIX loops and these tend to rotate as a unit about the loops. This rotation is resisted by the prop abutting the floor of the car. On rebound due to resilience, the base can rotate by a restricted amount only before the anti-rebound member 38 is pressed into the adult seat back and the rotation of the base is restricted by the stops 39. Thus the infant carrier is stopped from flipping back into the seat back. It is on rebound that inertia of the release member 41 could cause it to release the infant carrier. This is prevented the interlock 62.

Whilst the embodiment above has been described in connection with a Group 0+ rear-facing infant carrier, it is also suitable for other safety seats such as a forwards-facing or rear-facing Group 1 child safety seat.

It should be noted that the mouldings referred to in this description are mouldings of plastics materials, conveniently of polypropylene.

The invention is not intended to be restricted to the details of the above described embodiment, which can be varied for instance as shown in FIG. 11 by inclusion of a retainer 101 for the hooks 45 in their disengaged position without an infant carrier engaged on the base. The button 60 has an indicator for indicating that the button is in its position corresponding to the hooks being in their engagement position, the indicator being a green mark 102 on a portion of the button that extends out of the upper moulding 2 when the hooks are engaged. The retainer holds the hooks back and the button in when there is no infant carrier. As shown, the retainer is an arm 103 pivoted 104 on a moulding 105. The latter has a foot 106 with a spigot 107 engaging in one aperture 1071 in the upper moulding and with a rivet 108 securing the foot at opposite apertures 1091,1092 in these components. The moulding is sized such that the pivot 104 is directly in front of the hook 45, in the line of its action towards its engaged position.

Both the foot 106 and an extension 110 of the arm on the side thereof remote from the hook 45 have spigots 1111,1112 for locating a spring 112, which urges the hook abutting end 113 of the arm upwards into the path of the hook. Movement of the arm in this direction is limited by abutment with an edge 114 of the opening 49 for the hook in the upper moulding. To ensure that a portion of the arm extends far enough into the path of the bar 51 for proper operation, the distal end of the arm has an upstand 115. In the quiescent state of the device, the arm holds the hook back from the opening and the green mark 102 is not visible.

As the infant carrier is fitted, the bar 51 abuts the upstand 115 and depresses the arm 103 compressing the spring 112. The hook 45 is free to move forwards and the bar is engaged. The button moves out and the green mark is exposed to indicate that the infant carrier is properly engaged. On removal of the infant carrier, by depression of the button, the arm 103 springs in front of the hook 45 as the bar 51 is lifted with the infant carrier, the button still being depressed. Release of the button brings the hook into abutment with the arm, whereby the button does not spring out to show the green mark 102. The hook is sprung 67 but does not displace the arm, since the latter is in compression with its distal end 116 square to the line of action 117 of the hook on it, whereby it does not rotate about the pivot under action of the spring 67.

1. A base for a child safety support for use in a vehicle with an adult seat equipped with attachment points, the base comprising:
a body configured for positioning on the cushion of an adult seat;
a plurality of complementary attachment latches for cooperation with the attachment points attached to the rear of the body;
a foot prop attached proximate the front of the body for extending past the front edge of the cushion of the adult seat and for abutting the floor of the vehicle;
a safety support engagement mechanism for engaging a child safety support to the body; and
an anti-rebound member carried by the body for abutting against the back of the adult seat to resist rebound rotation of the body about the attachment latches in the event of an accident.

2. A base according to claim 1, wherein the body is of a construction with sufficient inherent strength to resist accident loads.

3. A base according to claim 1, wherein the body includes a reinforcement, connecting the attachment latches to the safety support engagement mechanism.

4. A base according to claim 3, wherein the reinforcement is in the form of a U-shaped metal frame having the attachment latches at respective distal ends of its limbs.

5. A base according to claim 4, wherein the attachment latches and limbs are directly connected.

6. A base according to claim 4, wherein the attachment latches and limbs are connected via a cross-member interconnecting the distal ends, and having the attachment latches at the terminal ends of the cross-member.

7. A base according to claim 3, wherein the attachment latches are pivotally attached to the reinforcement.

8. A base according to claim 6, wherein the attachment latches are pivoted via the cross-member.

9. A base according to claim 6, wherein the anti-rebound member is attached to the cross-member.

10. A base according to claim 9, wherein the anti-rebound member is pivotal about the cross-member and is provided with abutments with the top surface of the base to limit the movement of the member and the top surface towards each other in a rebound.

11. A base according to claim 1, wherein the foot prop is attached at a front end of the body.

12. A base according to claim 4, wherein the safety support engagement mechanism is configured as two pairs of hooks pivoted to the U-frame and ganged together for resilient urging to their engaged position.

13. A base according to claim 12, wherein a central longitudinal member is provided for the ganged connection.

14. A base according to claim 13, wherein the ganged connection is provided with an inertia interlock, releasable on application of manual force to release the engagement means.

15. A base according to claim 1, further comprising:
a button moveable from an engaged position to a release position for releasing the child safety support from the safety support engagement mechanism, the button being provided with an indicator for indicating that the button is in an engaged position when the safety support engagement mechanism is correctly engaging the child safety support to the body.

16. A base according to claim 15, wherein said indicator is hidden within said body when the child safety support is not engaged to the safety support engagement mechanism.

17. A base according to claim 15, wherein said indicator indicating that the button is in an engaged position corresponds to the hooks being in their engagement position.

18. A base according to claim 17, further comprising a retainer for retaining the hooks in a disengaged position and the button in a release position without the indicator indicating engagement when no child safety support is engaged on the base.

19. A base according to claim 15, wherein the button is provided at the end of the central longitudinal member opposite from the attachment latches.

20. A base according to claim 18, wherein:
the retainer is a pivoted arm arranged to abut one of the hooks in its disengaged and extend from a point of abutment in the direction of the line of movement of the hook towards its engaged position,
a pivot for the arm being provided remote from the point of abutment in the direction of the arm's extension, whereby the resilient urging of the hook to its engaged position does not deflect the arm and
a spring is provided for urging the arm to its hook retaining position, when displaced therefrom on engagement of a child safety support on the base.

21. A base according to claim 20, wherein the pivot is provided on a member attached to the inside of an upper skin of the body, the member and an extension of the arm from the pivot remote from the hook being provided with spring location points.

22. A base according to claims claim 1, comprising mouldings formed from plastics materials.

23. A base according to claim 1, wherein said child safety support is a Group 0+ rear-facing infant carrier or forward-facing or a rear-facing Group 1 child safety seat.

24. A combination of a base according to claim 1 and an infant carrier or a child safety seat.
